(19) United States
(12) Patent Application Publication
(10) Pub. No.: US 2012/0161960 A1
(43) Pub. Date: Jun. 28, 2012

(54) BODY FLUID ABSORPTION OBJECT WETTING ALARM METHOD AND APPARATUS

(76) Inventors: PO-HSUN CHENG, KAOHSIUNG CITY (TW); MEI-JU SU, HSINCHU CITY (TW); HSIAO-CHUNG TSAI, TAOYUAN COUNTY (TW); JER-JUNN LUH, TAIPEI CITY (TW); HUNG-HSIN WU, TAIPEI CITY (TW)

(21) Appl. No.: 13/287,179

(22) Filed: Nov. 2, 2011

(30) Foreign Application Priority Data
Dec. 27, 2010 (TW) 099146134

(51) Int. Cl. G08B 21/20; G08B 1/08

(52) U.S. Cl. 340/539.12; 340/573.5

(57) ABSTRACT

A body fluid absorption object wetting alarm method and an apparatus associated are revealed. A light wavelength sensor is disposed on a body fluid absorption unit for detecting wavelength of the body fluid absorption unit. After the body fluid absorption unit becoming wet, the wavelength thereof changes. Then warning signals are sent to the receiving and checking unit. Thus, a caregiver at a management end of the receiving and checking unit knows that the body fluid absorption object worn by a care recipient was already wet and there is a need to replace the wet body fluid absorption unit with a new one immediately.

### BACKGROUND OF THE INVENTION

1. Field of the Invention

The present invention relates to an alarm method and an alarm apparatus associated, especially to a body fluid absorption object wetting alarm method, and an apparatus associated that detect the wavelength of a body fluid absorption object with high sensitivity. Thus caretakers can know the wetting of the body fluid absorption object worn by care recipients precisely and change the body fluid absorption object worn immediately.

2. Description of Related Art

For people who need care such as babies, the retarded, the disable, etc., it's harder for them to control their behaviors, including, urinating and defecating. Thus, they need to wear diapers, and this reduces caregiver's stress and worries.

After urinating and defecating, the care recipient's diaper contains excrement therein. If the caretaker didn't change the diaper in time, the care recipient may have skin infection such as diaper rashes caused by bacteria in excrement. Thus, it is important for caregivers to check the diapers when wetting and soiling occurs and replaces a new diaper.

### SUMMARY OF THE INVENTION

Therefore, it is a primary object of the present invention to provide a body fluid absorption object wetting alarm method, and an apparatus associated that detect the wavelength of diapers sensitively and further allow caretakers to learn the wetness of diapers and change care recipients' diapers as soon as possible.

In order to achieve the above object, a body fluid absorption object wetting alarm apparatus of the present invention includes a body fluid absorption unit, a detection and transmission unit, and a receiving and checking unit. The detection and transmission unit is arranged at the body fluid absorption unit. The detection and transmission unit consists of a light wavelength sensor, a microprocessor electrically connected to the light wavelength sensor, a power supply electrically connected to the microprocessor, and a transmitter electrically connected to the microprocessor. The receiving and checking unit is composed of a processor, a receiver electrically connected to the processor, a power supply electrically connected to the processor, and a transceiver electrically connected to the processor. The transceiver is electrically connected to a management end.

Thereby, the light wavelength sensor detects wavelength change caused by moisture of the body fluid absorption unit and sends warning signal to the receiving and checking unit. Thus, the caretaker at a management end of the receiving and checking unit learns that the body fluid absorption unit has become wet and changes the wet body fluid absorption unit worn by the care recipient immediately.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram showing structure of a detection and transmission unit of an embodiment according to the present invention;

FIG. 2 is a block diagram showing structure of a receiving and checking unit of an embodiment according to the present invention;

FIG. 3 is a perspective view of an embodiment according to the present invention;

FIG. 4 is a cross-sectional view of another embodiment according to the present invention;

FIG. 5 is a perspective view of a further embodiment according to the present invention.

### DETAILED DESCRIPTION OF THE PREFERRED EMBODIMENT

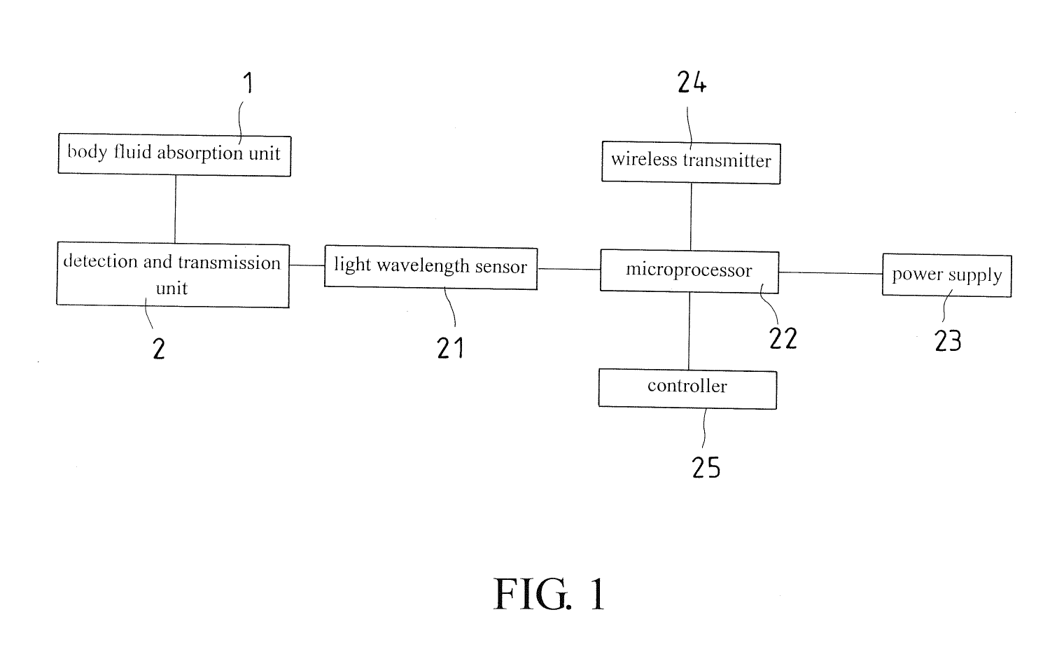

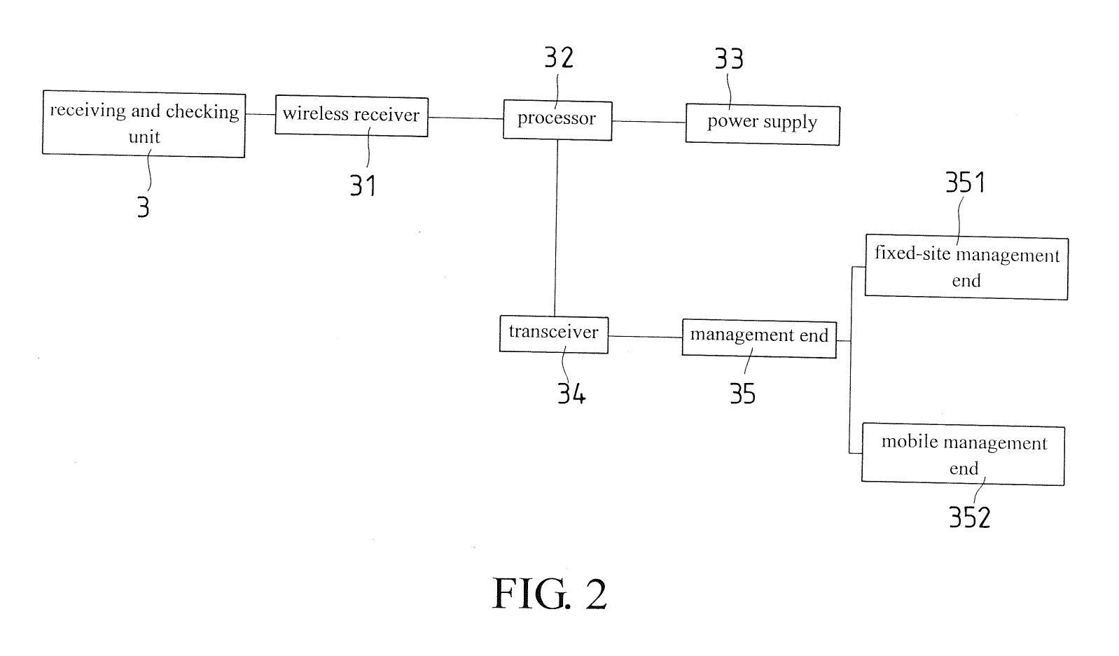

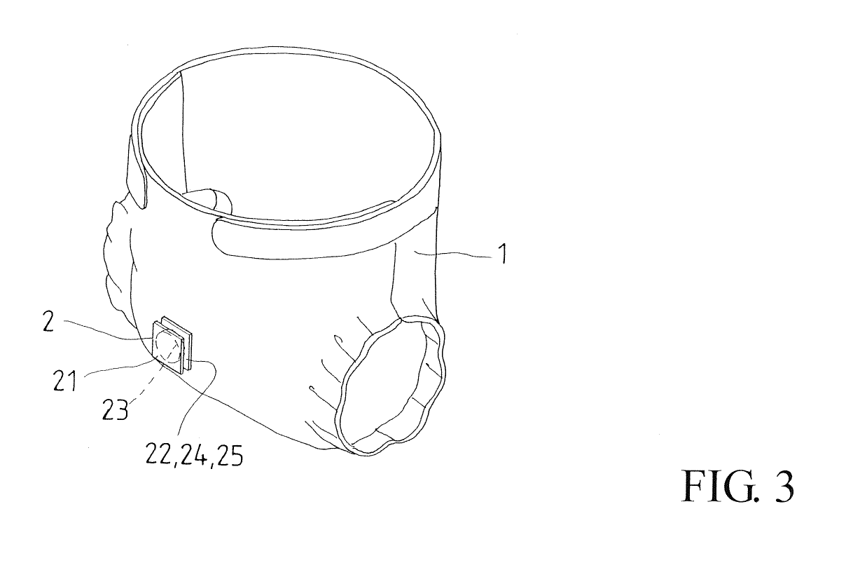

Refer from FIG. 1 to FIG. 3, a body fluid absorption object wetting alarm apparatus of the present invention mainly includes a body fluid absorption unit 1 (such as diaper), a detection and transmission unit 2, and a receiving and checking unit 3.

The detection and transmission unit 2 is assembled on the body fluid absorption unit 1. The detection and transmission unit 2 consists of a light wavelength sensor 21 connected to a light source, a microprocessor 22 electrically connected to the light wavelength sensor 21, a power supply 23 electrically connected to the microprocessor 22, a wireless transmitter 24 such as RFID electrically connected to the microprocessor 22, and a controller 25 electrically connected to the microprocessor 22 for setting parameters of the light wavelength.

The receiving and checking unit 3 is composed of a wireless receiver 31 for receiving signals from the wireless transmitter 24, a processor 32 electrically connected to the wireless receiver 31, a power supply 33 electrically connected to the processor 32, a transceiver 34 electrically connected to the processor 32, and a management end 35 electrically connected to the transceiver. The management end 35 includes a fixed-site management end 351 and a mobile management end 352. The fixed-site management end 351 can be computers, etc.; while the mobile management end 352 is a portable device such as a mobile phone. The signals from the detection and transmission unit 2 are displayed on the management end 35. Moreover, parameters such as humidity are set by the management end 35.

While in use, people who need care such as babies, the mentally retarded, the disable, etc. wears the body fluid absorption unit 1 with the detection and transmission unit 2, and the power supply 23 of the detection and transmission unit 2 is turned on. As to the power supply 33 of the receiving and checking unit 3, it is also activated.

Once people who need care urinate, defecate or excrete fluid in the body fluid absorption unit 1, the wavelength of the light coming from the light source of the light wavelength sensor 21 and projected to the body fluid absorption unit 1 is changed. At this moment, the light wavelength sensor 21 detects the wavelength change of the body fluid absorption unit 1 and sends a wavelength change signal detected to the microprocessor 22. In the microprocessor 22, the change of the wavelength is compared with a preset value of the wavelength. If the change reaches the preset value, the microprocessor 22 drives the wireless transmitter 24 for sending signals to the wireless receiver 31 of the receiving and checking unit 3.

After receiving the signals, the wireless receiver 31 sends the signals to the processor 32. In accordance with the signals from the wireless receiver 31, the processor 32 determines which body fluid absorption unit 1 worn by the person being cared is wet, and checks whether the wetness reaches a standard over which the body fluid absorption unit 1 should be replaced with a new one. If the wetness reaches the preset value, the processor 32 sends signals, passing through the transceiver 34, to the management end 35. Through a receiver (such as a display or a mobile phone), a caretaker at the management end learns that the body fluid absorption unit 1 on the person who need care have become wet and there is an urgent need to replace the body fluid absorption unit 1. According to the sensitive detection mechanism, diseases such as diaper rash caused by long-term wearing of the contaminated and wet body fluid absorption unit 1 can be prevented.

In the present invention, the light wavelength sensor 21 is used to detect whether the body fluid absorption unit 1 is wet. Once the body fluid absorption unit 1 has become contaminated and wet by excrement such as urine or feces, the wavelength of the body fluid absorption unit 1 changes (has a change) and the light wavelength sensor 21 immediately detects the change. In practice (use), the present invention has high sensitivity and accuracy. The condition that no warning is received although the body fluid absorption unit 1 has become soiled and wet will not occur.

Moreover, due to wireless transmission, the caretaker is not necessary to stay around the care recipient. Even he/she is far away from the care recipient, he/she can still know whether the body fluid absorption unit 1 worn by the care recipient is wet clearly. Thus, the metal pressure of the caretaker is reduced and the caretaker can also deal with other things besides taking care of the care recipient. The caretaker can use their time well.

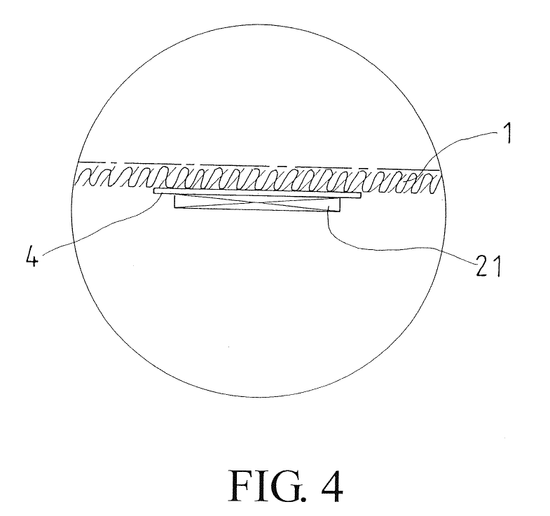

Refer to FIG. 4, another embodiment is revealed. A color-changing area 4 is arranged at the body fluid absorption unit 1. The color-change area 4 is coated with power or test paper that changes color after being reacted with water. The power can be chemicals such as cobaltous chloride and the test paper is embedded with cobaltous chloride. The light wavelength sensor 21 is in contact with the color-change area. Thereby when care recipients urinate, defecate or excrete fluid in the body fluid absorption unit 1 and the body fluid absorption unit 1 is contaminated or wet, the powder of the test paper changes from the anhydrous form (blue color) into the hexahydrate form (red color) with different color after being reacted with water, Thereby the obvious color change causes the light wavelength sensor 21 detects wetting of the body fluid absorption unit 1 more precisely and caretakers are informed to change the body fluid absorption unit 1.

Furthermore, a heat dryer is arranged at the color-change area 4 of the body fluid absorption unit 1, and the heat dryer is electrically connected to the microprocessor 22. While the light wavelength sensor 21 detects the color of the cobaltous chloride powder or the cobalt chloride paper on the color-change area 4 is changing and allow the microprocessor 22 to send signals, the heat dryer is activated at the same time so as to dry the hydrated from of cobaltous chloride on the color-change area 4. Thus, the cobaltous chloride can be used again. Therefore, effective use of resources and environmental benefits are achieved.

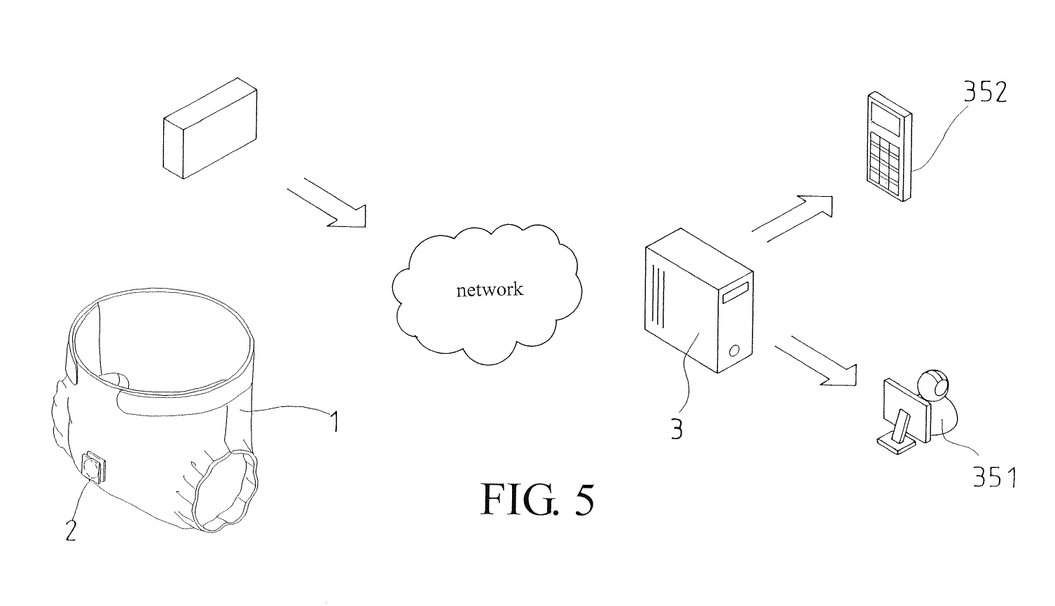

Refer to FIG. 5, the wireless transmitter 24 of the detection and transmission unit 2 and the wireless receiver 31 of the receiving and checking unit 3 can be replaced by a wireless network. Thereby, the microprocessor 22 sends warning signals such as electrical mails to the processor 32 of the receiving and checking unit 3 after the light wavelength sensor 21 detecting the wavelength changed caused by the wet body fluid absorption unit 1 and sending signals to the microprocessor 22. Then the transceiver 34 sends the warning signals to the management end 35 for display. Therefore, the caretaker knows that the body fluid absorption unit 1 on the care recipient has become wet and changes the diaper as needed. This is a further embodiment of the present invention.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A body fluid absorption object wetting alarm method comprising the steps of:
A. using a light wavelength sensor to detect the wavelength of a body fluid absorption object;
B. sending warning signals to a caregiver when the body fluid absorption object is wet and the wavelength of the body fluid absorption object changes; and
C. allowing the caregiver to change the wet body fluid absorption object worn by a care recipient after receiving warning signals.

2. The method as claimed in claim 1, wherein the light wavelength sensor is electrically connected to a wireless transmitter for sending signals, and a wireless receiver is used to receive signals from the wireless transmitter so that the caregiver knows that the body fluid absorption object worn by a care recipient is wet even at long distance.

3. The method as claimed in claim 1, wherein in the step A the body fluid absorption object is disposed with a color-change area that changes color after reacting with water; the light wavelength sensor is corresponding to the color-change area so that the light wavelength sensor detects wetting of the body fluid absorption object more easily and quickly.

4. The method as claimed in claim 3, wherein a heat dryer is disposed on the color-change area for drying the color-change area after the color-change area reacting with water and changing color so that the color-change area can be used again.

5. A body fluid absorption object wetting alarm apparatus comprising:
a body fluid absorption unit;
a detection and transmission unit that is arranged at the body fluid absorption unit; the detection and transmission unit having a light wavelength sensor, a microprocessor electrically connected to the light wavelength sensor, a power supply electrically connected to the microprocessor, and a transmitter electrically connected to the microprocessor; and
a receiving and checking unit that includes a processor, a receiver electrically connected to the processor and used for receiving signals from the transmitter of the detection and transmission unit, a power supply electrically connected to the processor, a transceiver electrically connected to the processor, and a management end electrically connected to the transceiver.

6. The device as claimed in claim 5, wherein the transmitter of the detection and transmission unit is a wireless transmitter while the receiver of the receiving and checking unit is a wireless receiver for receiving signals from the wireless transmitter.

7. The device as claimed in claim 5, wherein the management end of the receiving and checking unit includes a fixed-site management end and a mobile management end.

8. The device as claimed in claim 5, wherein the detection and transmission unit further includes a controller, and the controller is electrically connected to the microprocessor.

9. The device as claimed in claim 5, wherein the body fluid absorption object wetting alarm apparatus further includes a color-changing area arranged at the body fluid absorption unit and the light wavelength sensor is assembled over the color-changing area.

10. The device as claimed in claim 9, wherein the body fluid absorption object wetting alarm apparatus further includes a heat dryer disposed on the color-change area of the body fluid absorption unit and the heat dryer is electrically connected to the microprocessor.
